(19) United States
(12) Patent Application Publication
(10) Pub. No.: US 2026/0063528 A1
(43) Pub. Date: Mar. 5, 2026

(54) TWO-CHANNEL EXTRUSION DIE FOR MOONEY CORRECTION

(71) Applicant: RIKEN TECHNOS CORPORATION, Tokyo (JP)

(72) Inventor: Xuhui WANG, Burlington, NJ (US)

(21) Appl. No.: 18/817,702

(22) Filed: Aug. 28, 2024

(51) Int. Cl. G01N 11/04

(52) U.S. Cl. CPC G01N 11/04

(57) ABSTRACT

Disclosed is a two-channel extrusion die for Mooney correction to determine true shear viscosity of a resin, comprising: a cylindrical body; and two channels, each of the two channels having a circular and constant cross section and extending linearly throughout the channel along a longitudinal direction of the cylindrical body, and when a big channel A has a longitudinal length L_{A} and a diameter D_{A} of a cross section, and a small channel B has a longitudinal length L_{B} and a diameter D_{B} of a cross section, all of three relations (i) L_{A}>L_{B}; (ii) D_{A}>D_{B}; and (iii) L_{A}/D_{A}=L_{B}/D_{B} being fulfilled, thereby causing each of the two channels to equally be under a given pressure head of from an inlet to an outlet of the channel during an extrusion operation of a fluid of the resin.

### FIELD OF THE INVENTION

The present invention relates to the filed of Mooney correction, i.e., correction of the wall-slip effect in rheological properties measurement with a rheometer. Specifically, the present invention is directed to a two-channel extrusion die with pressure flow, which is used for making Mooney correction in rheological properties measurement with a rheometer.

### DESCRIPTION OF THE RELATED ART

Shear viscosity of a polymer melt (either in fluid state or visco-elastic state) is an essential physical property to design formulation, define mold geometry and set up processing details. To obtain true shear viscosity, Mooney correction is needed for viscosity measurement.

This correction needs two or more dies with the same L/D ratio to be tested by a rheometer under the same pressure head. (Hereinafter, the term fluid state shall include the meaning of the term visco-elastic state.)

Mooney correction has been commonly used to determine the wall slip velocity for wall-slip materials such as HDPE or PVC resins. The model for Mooney correction is made on the assumption that the material with a constant wall slip velocity Vₛ is slipping at a wall in the model. Conventionally, Mooney correction has been applied to slit die geometries and to rotational rheometry.

The following description about the conventional method is focused on the analysis of capillary die extrusion rheometry data for the determination of slip velocity which was first proposed by Mooney. The term “slip” is used herein to signify either a large velocity change near the wall that could be attributed to either a thin, high shearing layer with zero wall velocity, or to a non-zero wall velocity. Slip flow can be modelled by the addition of a slip flow velocity to the shear flow velocity profile, which assumes that the slip layer can support a shear stress that is necessary for the shear flow to occur. When the total volume flow rate, the shear volume flow rate and the slip volume flow rate of a fluid are assigned to Q_{T}, Qₛₕₑₐᵣ and Qₛₗᵢₚ, respectively, the following equation is met.

$${Q}_{T} = {Q}_{shear} + {Q}_{slip}$$

The fluid is assumed to be incompressible. For flow in a capillary die of radius R, the slip flow rate Qₛₗᵢₚ is given by the following equation where Vₛ is the slip velocity.

$${Q}_{slip} = {V}_{s} π {R}^{2}$$

Shear viscosity η is defined as the ratio of shear stress τ to shear rate γ′, as shown in the following equation.

$$η = τ / γ ,$$

The shear viscosity power-law model can be written as follows.

$$η = K {γ}^{′ n - 1}$$

where K and n are predetermined constants.

For a power-law fluid, the true wall shear-rate γ′_{w} for flow in a cylindrical die is given according to the study by Brydson and Rabinowitsch as follows.

$${γ}_{w}^{′} = [ ( 3 n + 1 ) / 4 n ] * ( 4 Q / π {R}^{3} )$$

Using these equations, the following expression for the total flow rate in the presence of slip can be derived.

$${Q}_{T} = [ n π {R}^{3} / ( 3 n + 1 ) ] * {[ {τ}_{w} / K ]}^{1 / n} + {V}_{s} π {R}^{2}$$

where τ_{w} is a wall shear stress.

This equation means that the dependence of the slip velocity Vₛ on wall shear stress will determine the shape of the plot.

Following the study of Lupton and Register, the above equation is rewritten as follows.

$$4 {Q}_{T} / π {R}^{3} = [ 4 n / ( 3 n + 1 ) ] * {[ {τ}_{w} / K ]}^{1 / n} + 4 {V}_{s} / R$$

On the assumption that the wall shear stress is constant and n and K do not vary with flow rate, the above equation is simply rewritten as follows.

$$4 {Q}_{T} / π {R}^{3} = constant + 4 {V}_{s} / R$$

This equation means that, for a given wall shear stress, a plot of apparent wall shear rate 4 Q_{T}/πR³ versus 1/R will have a gradient of 4Vₛ, by which the slip velocity can be determined.

Conventionally, the slip velocity of a fluid can be determined according to the following steps:
i) measuring the shear stress versus apparent shear rate behavior of the material in accordance with ISO 11443 using at least two sets of dies of different diameters, yielding one flow curve for each diameter;
ii) determining, by interpolation, the apparent shear rates corresponding to selected shear stress values for each die diameter;
iii) for each selected shear stress, plotting the interpolated apparent shear rate values versus the reciprocal of the die radius, thereby determining the gradient of the linear plot to the data; and
iv) calculating the slip velocity by the gradient of iii) divided by 4.

Mooney correction, which has been commonly used to determine the wall slip velocity for wall-slip materials, needs two or more dies with the same L/D ratio to be tested by a rheometer under the same pressure head. Testing through multiple dies in such a manner requires not only multiple dies but also multiple test cycles. Disadvantageously, such a conventional method is a time-consuming process. Moreover, it is difficult to secure two different flow channels under the same shear stress with standard capillary rheometers because it is very hard to secure identical pressure heads when running two or more channels separately. In other words, one cannot ensure multiple tests are accurately under the same shear stress when a conventional capillary rheometer is used as most rheometers are shear-rate (speed) controlled. Then the value of shear rate needs to be estimated by a flow curve or viscosity model for the same shear stress points. The process involves more testing actions (at least twice of flow tests) and an accompanied data treatment. Therefore, there is another disadvantage that a complicated data treatment is needed to simulate the shear rate at a given shear stress, as mentioned in the above paragraph. In addition, it needs investment of expensive rheometer and dies.

### SUMMARY OF THE INVENTION

The present inventor has found that a two-channel extrusion die having a specific structure can overcome the above-mentioned disadvantages caused by the conventional method (typically using the conventional capillary rheometer) for Mooney correction and enables two flow channels to be accurately under the same pressure head ΔP without running two or more channels separately and without need of any complicated data treatment, by which he made the present invention. As the two channels of the die are made of the same L/D value, they can be under the same shear stress (i.e., the condition required for Mooney's Theory). The two-channel extrusion die can noticeably simplify the method for making Mooney correction for true shear viscosity.

A preferred embodiment of the present invention is as follows:
a two-channel extrusion die for Mooney correction to determine true shear viscosity of a resin,
the two-channel extrusion die, comprising:
   a cylindrical body;
   two channels, each of the two channels having a circular and constant cross section and extending linearly throughout the channel along a longitudinal direction of the cylindrical body, and both inlets of the two channels existing in a plane perpendicular to the longitudinal direction of the cylindrical body, and
   a convex part adapting to an extruder; and
when a big channel A being one of the two channels has a longitudinal length L_{A} along the longitudinal direction of the cylindrical body and a diameter D_{A} of a cross section perpendicular to the longitudinal direction, and a small channel B being the other of the two channels has a longitudinal length L_{B} along the longitudinal direction of the cylindrical body, and a diameter D_{B} of a cross section perpendicular to the longitudinal direction, all of three relations (i), (ii) and (iii) shown below being fulfilled, thereby causing each of the two channels to equally be under a given pressure head of from an inlet to an outlet of the channel during an extrusion operation of a fluid with the two-channel extrusion die:

$${L}_{A} > {L}_{B} \qquad ( i )$$

$${D}_{A} > {D}_{B} \qquad ( ii )$$

$${L}_{A} / {D}_{A} = {L}_{B} / {D}_{B} . \qquad ( iii )$$

The two-channel extrusion die enables one to generate a pressure flow for two channels under the same pressure head, which can create the same shear stress for the two channels with an equal L/D ratio but different diameters. This set up of the two-channel extrusion die enables one to apply Mooney correction with a single round of extrusion operation without need of die change and without need of any complicated data treatment. Advantageously, one can obtain shear rate information under the same shear stress directly without any complicated data simulation from multiple tests to find an identical shear stress point just by using this simple two-channel extrusion die. In other words, there are unexpectedly advantageous effects caused by the two-channel extrusion die, as follows: 1) an easy and quick way to apply Mooney correction for true shear viscosity can be provided; and 2) an operation cost can be made significantly lower because of no need of a conventional rheometer accompanied by conducting multiple tests with multiple dies.

### BRIEF DESCRIPTION OF THE DRAWINGS

FIG. 1 is a planer view and an A-A′ cross-sectional view of a preferred embodiment of the two-channel extrusion die.

FIG. 2 is a perspective view of an appearance of a preferred embodiment of the two-channel extrusion die.

FIG. 3 is planer views and A-A′ cross-sectional views of two channels (i.e., a big channel A and a small channel B) made in a preferred embodiment of the two-channel extrusion die.

FIG. 4 is a planer view of other preferred embodiment of the two-channel extrusion die.

FIG. 5 is perspective views from the front side of two types of two-channel extrusion dies used in working examples, where one of the two-channel extrusion dies (i.e., the drawing on the left) has diameters of big and small channels which are less than diameters of big and small channels of the other two-channel extrusion die (i.e., the drawing on the right), respectively.

FIG. 6(a) is a perspective view from the bottom of each of the two types of two-channel extrusion dies used in working examples. FIG. 6(b) is a front view of each of the two types of two-channel extrusion dies used in working examples. FIG. 6(c) is a plan view of each of the two types of two-channel extrusion dies used in working examples.

### DETAILED DESCRIPTION OF THE INVENTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

For purposes of the following description, it is to be understood that embodiments provided by the present disclosure may assume various alternative variations and step sequences, except where expressly specified to the contrary. Moreover, other than in the examples, or where otherwise indicated, all numbers expressing, for example, quantities of ingredients used in the specification and claims are to be understood as being modified in all instances by the term “about.” Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that, in this application, the use of “or” means “and/or” unless specifically stated otherwise, even though “and/or” may be explicitly used in certain instances. As used herein, the terms “comprises”, “comprising”, “includes”, “including”, “has”, “having” or any other variation thereof, are open-ended terms and should be interpreted to mean “including, but not limited to . . . .”

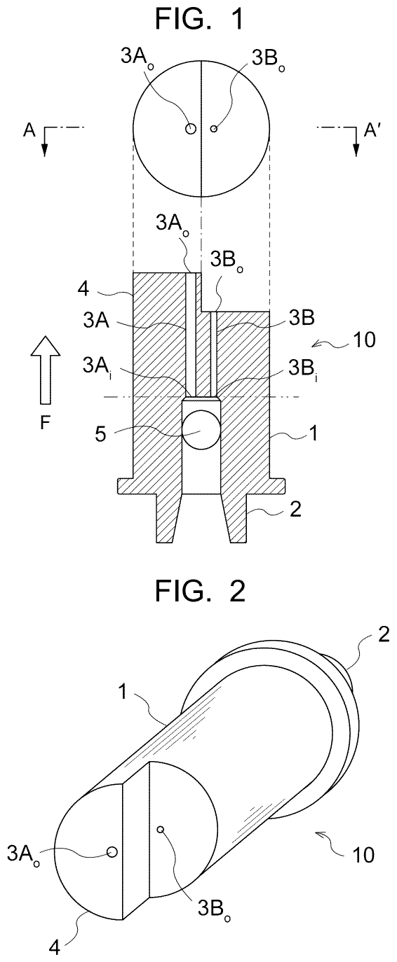

A preferred embodiment of a two-channel extrusion die for Mooney correction according to the present invention is illustrated in FIGS. 1 and 2. This is just an example, but the present invention is not limited to the specific structure shown in the drawing. Especially, all dimensions mentioned later can be adjusted or controlled depending on various factors, for example, extruder size and targeted polymers.

The upper drawing of FIG. 1 is a planer view of a two-channel extrusion die for Mooney correction (10) and the lower drawing of FIG. 1 is an A-A′ cross-sectional view of the two-channel extrusion die (10). FIG. 2 is a perspective view of an appearance of the two-channel extrusion die (10) illustrated in FIG. 1. In FIG. 1, a two-channel extrusion die for Mooney correction (10) comprises a cylindrical body (1) having an elongated shape, a convex part (2) capable of adapting to an extruder of a resinous fluid, a big channel (3A) with a larger longitudinal length L_{A} and a larger diameter D_{A} and a small channel (3B) with a smaller longitudinal length L_{B} and a smaller diameter D_{B}. Typically, the cylindrical body (1) has a cylindrical contour in a substantially entire part as shown in FIGS. 1 and 2, but it may partially have a contour other than cylindrical shape.

Both the big channel A and the small channel B have a substantially circular and substantially constant cross section and extends linearly throughout the channel along a longitudinal direction of the cylindrical body (1). In other words, the big channel A extends linearly from an inlet (3Aᵢ) to an outlet (3Aₒ) and the small channel B extends linearly from an inlet (3Bᵢ) to an outlet (3Bₒ) (see FIGS. 1 and 2). The longitudinal direction of the big channel (3A) and the longitudinal direction of the small channel (3B) are substantially parallel to each other. Both the inlet (3Aᵢ) of the big channel (3A) and the inlet (3Bᵢ) of the small channel (3B) exists in a plane substantially perpendicular to the longitudinal direction of the cylindrical body (1). Because of this structural feature, the physical conditions of an extruded resinous flow at the inlet (3Aᵢ) of the big channel (3A) can be made fully consistent with the physical conditions of the extruded resinous flow at the inlet (3Bᵢ) of the small channel (3B) so as to create the same shear stress, thereby enabling to contribute to accurately making Mooney correction and determining the slip velocity.

Reference sign “F” shown in FIG. 1 represents the flow direction of a resinous fluid when the resinous fluid is extruded from an extruder into the big channel (3A) and the small channel (3B). The extruded resinous flow can go forward simultaneously from the inlet (3Aᵢ) to the outlet (3Aₒ) in the big channel (3A) and from the inlet (3Bᵢ) to the outlet (3Bₒ) in the small channel (3B).

The convex part (2) provided in the vicinity of the upstream end of the cylindrical body (1) is not limited particularly as long as it is capable of adapting to an extruder and it does not prevent an extrusion operation. As illustrated in FIG. 1, the convex part (2) may have a ring-shaped projection so that a periphery of the projection can fit to an inner surface of the extruder, for example. The convex part (2) may further have an annular part projecting toward the outside of the circumference on the border of the cylindrical body (1). An instrument to measure a temperature and/or pressure of a fluid to be extruded with the two-channel extrusion die may be connected to the cylindrical body (1) at a position (5). The measurement instrument can be set at the position (5) capable of contacting the fluid (when it is flown for the extrusion). The measurement instrument can have an indicator. The position (5) connecting to the measurement instrument may form a hole or a space installing the measurement instrument. The position (5) may be for mounting a pressure transducer. Such a pressure transducer is required to be in the position of a common reservoir exerting the same pressure to both the big and small channels.

As illustrated in FIGS. 1 and 2, a semicylindrical convex part (4) may be provided at the downstream end of the cylindrical body (1). When it is provided, the big channel (3B) passes through the semicylindrical convex part (4), and the outlet (3Bₒ) of the big channel (3B) is present on the downstream-side surface of the semicylindrical convex part (4).

The big channel (3A) and the small channel (3B) of the two-channel extrusion die (10) are required to fulfill all of three relations (i), (ii) and (iii) shown below:

$${L}_{A} > {L}_{B} \qquad ( i )$$

$${D}_{A} > {D}_{B} \qquad ( ii )$$

$${L}_{A} / {D}_{A} = {L}_{B} / {D}_{B} . \qquad ( iii )$$

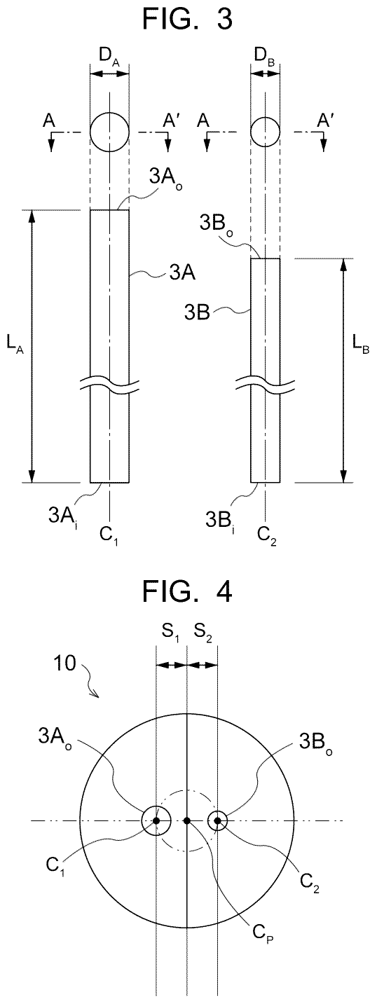

when the big channel (3A) has a longitudinal length L_{A} along the longitudinal direction of the cylindrical body (1) and a diameter D_{A} of a cross section perpendicular to the longitudinal direction, and the small channel (3B) has a longitudinal length L_{B} along the longitudinal direction of the cylindrical body (1) and a diameter D_{B} of a cross section perpendicular to the longitudinal direction. The upper drawing of FIG. 3 is planer views of the big channel (3A) and the small channel (3B). The lower drawing of FIG. 3 is A-A′ cross-sectional views of the big channel (3A) and the small channel (3B). In the preferred embodiment as shown in FIG. 3, the big channel (3A) extends straightly with the longitudinal length L_{A} and the constant diameter D_{A} from the inlet 3 Aᵢ to the outlet 3Aₒ along the central line C₁. In a similar manner, the small channel (3B) extends straightly with the longitudinal length L_{B} and the constant diameter D_{B} from the inlet 3Bᵢ to the outlet 3Bₒ along the central line C₂.

When all of the three relations (i), (ii) and (iii) are fulfilled, the two channels (3A, 3B) are each caused to be equally under a given pressure head of from the inlet (3Aᵢ or 3Bᵢ) to the outlet (3Aₒ or 3Bₒ) of the channel (3A or 3B). The two-channel extrusion die (10) can create the same shear stress for the big and small channels (3A, 3B) with an equal L/D ratio (i.e., L_{A}/D_{A}=L_{B}/D_{B}) but different diameters (D_{A}, D_{B}), which enables one to apply Mooney correction with a single round of extrusion operation without need of die change and without need of any complicated data treatment. This leads to great advantages of the development of an easy and quick way to accurately apply Mooney correction for true shear viscosity and a lower operation cost because of no need of a conventional rheometer accompanied by conducting multiple tests with multiple dies.

In the relationship between the longitudinal lengths of the two channels, L_{A} may be usually 1.1*L_{B} or larger and 2.0*L_{B} or smaller, although it is not limited thereto. In preferred embodiments, L_{A} may be 1.1*L_{B} or larger and 1.9*L_{B} or smaller, 1.1*L_{B} or larger and 1.8*L_{B} or smaller, 1.1*L_{B} or larger and 1.7*L_{B} or smaller, 1.1*L_{B} or larger and 1.6*L_{B} or smaller, 1.1*L_{B} or larger and 1.5*L_{B} or smaller, 1.1*L_{B} or larger and 1.4*L_{B} or smaller, 1.1*L_{B} or larger and 1.3*L_{B} or smaller, or 1.1*L_{B} or larger and 1.2*L_{B} or smaller.

In the relationship between the diameters of the two channels, D_{A} may be usually 1.1*D_{B} or larger and 2.0*D_{B} or smaller, although it is not limited thereto. In preferred embodiments, D_{A} may be usually 1.1*D_{B} or larger and 1.9*D_{B} or smaller, 1.1*D_{B} or larger and 1.8*D_{B} or smaller, 1.1*D_{B} or larger and 1.7*D_{B} or smaller, 1.1*D_{B} or larger and 1.6*D_{B} or smaller, 1.1*D_{B} or larger and 1.5*D_{B} or smaller, 1.1*D_{B} or larger and 1.4*D_{B} or smaller, 1.1*D_{B} or larger and 1.3*D_{B} or smaller, or 1.1*D_{B} or larger and 1.2*D_{B} or smaller. Any one of these usual and preferred ranges of the relationship between the diameters of the two channels may be combined with any one of the above usual and preferred ranges of the relationship between the longitudinal lengths of the two channels.

In the ratio of the length to diameter in each of the two channels, L_{A}/D_{A} and L_{B}/D_{B} each may be usually 5 or more and 50 or less. In preferred embodiments, L_{A}/D_{A} and L_{B}/D_{B} each may be 5 or more and 45 or less, 5 or more and 40 or less, 5 or more and 35 or less, 5 or more and 30 or less, 10 or more and 50 or less, 10 or more and 45 or less, 10 or more and 40 or less, 10 or more and 35 or less, 10 or more and 30 or less, 15 or more and 50 or less, 15 or more and 45 or less, 15 or more and 40 or less, 15 or more and 35 or less, 15 or more and 30 or less, 20 or more and 50 or less, 20 or more and 45 or less, 20 or more and 40 or less, 20 or more and 35 or less, or 20 or more and 30 or less.

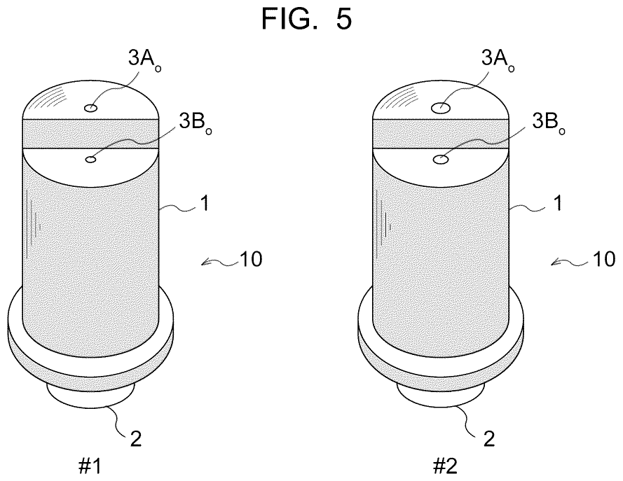

According to a preferred embodiment shown in FIG. 4, the end point of the central line C₁ of the big channel (3A) extending along the longitudinal direction of the cylindrical body (1), i.e., the center of the circle making the outlet (3Aₒ) of the big channel (3A) and the end point of the central line C₂ of the small channel (3B) extending along the longitudinal direction of the cylindrical body (1), i.e., the center of the circle making the outlet (3Bₒ) of the small channel (3B) are each equidistant from the end point of the central line of the cylindrical body (1) in a cross section perpendicular to the longitudinal direction of the cylindrical body (1) in the two-channel extrusion die (10). When each of the big channel (3A) and the small channel (3B) perfectly in parallel and straightly extends along the longitudinal direction of the cylindrical body (1), the starting point of the central line C₁ of the big channel (3A) extending along the longitudinal direction of the cylindrical body (1), i.e., the center of the circle making the inlet (3 Aᵢ) of the big channel (3A) and the starting point of the central line C₂ of the small channel (3B) extending along the longitudinal direction of the cylindrical body (1), i.e., the center of the circle making the inlet (3Bᵢ) of the small channel (3B) are each equidistant from the end point of the central line of the cylindrical body (1) in a cross section perpendicular to the longitudinal direction of the cylindrical body (1) in the two-channel extrusion die (10). This means that the distance S₁ between the center of big channel (3A) and the center of the cylindrical body (1) is equal to the distance S₂ between the center of big channel (3B) and the center of the cylindrical body (1). Because of this structural feature, the physical conditions of an extruded resinous flow at the inlet (3Aᵢ) of the big channel (3A) can be made more perfectly consistent with the physical conditions of the extruded resinous flow at the inlet (3Bᵢ) of the small channel (3B) so as to create the same shear stress, thereby enabling to contribute to more accurately making Mooney correction and determining the slip velocity.

The material for forming the two-channel extrusion die (10) is not particularly limited as long as it can have high hardness enough to conduct the extrusion operation of a resinous fluid for Mooney correction. Any known material may be use for forming the die. For example, the material may contain, in addition to Fe, one or more selected from C, Si, Mn, P, S, Cu, Ni, Cr, Mo, V, N, O and Al at controlled ratios according to needs.

The type of a resin to be extruded by the two-channel extrusion die (10) is not particularly limited as long as a resinous flow can keep a fluid state when it is subjected to the extrusion operation by the die connected to an extruder. The resin to be extruded may be typically a thermoplastic resin that a crystalline thermoplastic resin or an amorphous thermoplastic resin. Examples of the thermoplastic resin include, but are not limited to, polyolefin resins such as polyethylene resins and polypropylene resins; polyamide resins (PA resins) such as polyamide 6, polyamide 66, and metaxylylenediamine-based polyamide (MXD6); polyoxymethylene (polyacetal, POM) resins; polyester resins such as polyethylene terephthalate (PET) resin and polybutylene terephthalate (PBT) resin; polyphenylene sulfide resins; styrene resins such as polystyrene resin, ABS resin, AES resin, and AS resin; methacrylic resins; polycarbonate resins (PC resins); modified polyphenylene ether (PPE) resins; polysulfone resins; polyethersulfone resins; polyarylate resins; polyetherimide resins; polyamideimide resins; polyimide resins; polyetherketone resins; polyetheretherketone resins; polyestercarbonate resins; and liquid crystal polymers.

The type of an extruder capable of being connected to the two-channel extrusion die (10) is not particularly limited. Any known extruder can be selected depending on the type of a resin to be extruded or other extrusion conditions. The extruder may be either a single screw extruder or a twin screw extruder. Two or more of such extruders may be connected to each other.

Mooney correction may be usually made by the following five steps to determine true shear viscosity with the use of the two-channel extrusion die (10):
(1) extruding a fluid from the big channel (3A) and the small channel (3B) through the two-channel extrusion die (10) connecting to an extruder, thereby collecting an extrude A from the big channel (3A) and an extrude B from the small channel (3B);
(2) measuring a weight A of the extrude A and a weight B of the extrude B (where each weight is measured as weight per unit time);
(3) calculating an apparent shear rate A from the weight A and an apparent shear rate B from the weight B;
(4) applying Mooney correction to the apparent shear rate A and the apparent shear rate B, thereby determining a slip velocity of the fluid; and
(5) calculating a true shear viscosity from the slip velocity of the fluid.

In preferred additional embodiments, the two-channel extrusion die for Mooney correction comprises an extrusion die having three or more channels with same length over diameter ratios for Mooney correction fulfilling the following requirements, because the possession of the three or more channels inevitably include therein the two channels. In other words, the options of more than two channels can be perfectly in line with the inventive concept as well and they can be covered by this patent application. Such an extrusion die having three or more channels for Mooney correction can cause a great advantage of the acquisition of multiple data points for the Mooney curve after one round of extrusion.

<An extrusion die having three or more channels>

An extrusion die having three or more channels for Mooney correction to determine true shear viscosity of a resin,
the extrusion die having three or more channels, comprising:
   a cylindrical body;
   three or more channels, each of the three or more channels having a circular and constant cross section and extending linearly throughout the channel along a longitudinal direction of the cylindrical body, and all inlets of the three or more channels existing in a plane perpendicular to the longitudinal direction of the cylindrical body, and
   a convex part adapting to an extruder; and
   for any two channels chosen from the three or more channels, when a big channel A being one of the chosen two channels has a longitudinal length L_{A} along the longitudinal direction of the cylindrical body and a diameter D_{A} of a cross section perpendicular to the longitudinal direction, and a small channel B being the other of the chosen two channels has a longitudinal length L_{B} along the longitudinal direction of the cylindrical body, and a diameter D_{B} of a cross section perpendicular to the longitudinal direction, all of three relations (i), (ii) and (iii) shown below being fulfilled, thereby causing each of the three or more channels to equally be under a given pressure head of from an inlet to an outlet of the channel during an extrusion operation of a fluid with the extrusion die having three or more channels:

$${L}_{A} > {L}_{B} \qquad ( i )$$

$${D}_{A} > {D}_{B} \qquad ( ii )$$

$${L}_{A} / {D}_{A} = {L}_{B} / {D}_{B} . \qquad ( iii )$$

One or more of the embodiments previously described about the two-channel extrusion die may be similarly applied to the extrusion die having three or more channels unless the application cannot be considered feasible from a technical perspective.

For example, a plurality of partially cylindrical parts may be formed in stages (i.e., stepwise) at a downstream end of the cylindrical body of the extrusion die having three or more channels, and the biggest channel may pass through the end-position partially cylindrical part and the second biggest channel may pass through the partially cylindrical part provided at the second position from the end, and so on.

All the centers of the three or more channels may be each equidistant from a center of the cylindrical body in a cross section perpendicular to the longitudinal direction of the cylindrical body of the extrusion die having three or more channels. Alternatively, for at least two channels chosen from the three or more channels, the centers of the at least two channels may be each equidistant from a center of the cylindrical body in a cross section perpendicular to the longitudinal direction of the cylindrical body of the extrusion die having three or more channels.

For any two channels chosen from the three or more channels, L_{A} may be 1.1*L_{B} or larger and 2.0*L_{B} or smaller, and D_{A} may be 1.1*D_{B} or larger and 2.0*D_{B} or smaller. Also, for any two channels chosen from the three or more channels, L_{A}/D_{A} and L_{B}/D_{B} may be each 5 or more and 50 or less.

### EXAMPLES

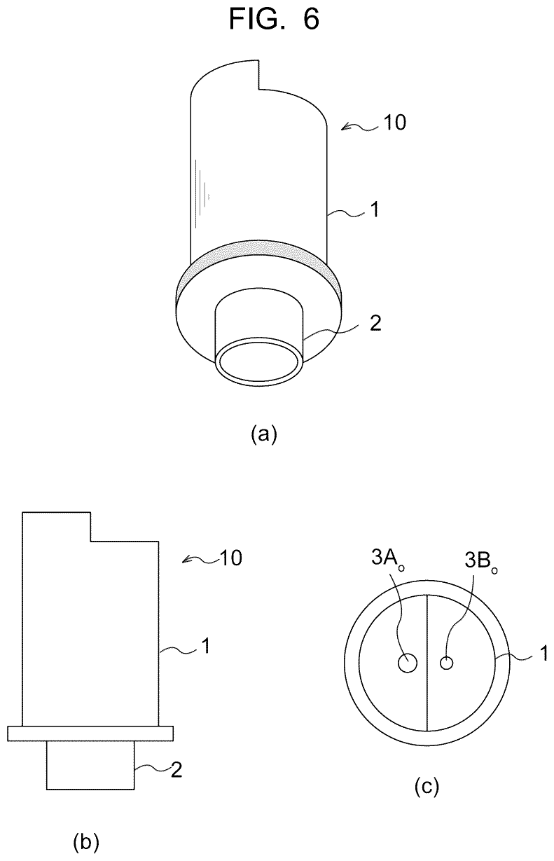

Two types of two-channel extrusion dies for Mooney correction (#1 and #2) each having a big channel and a small channel with dimensions as shown in Tables 1 and 2 below were used. The two-channel extrusion dies #1 was used in Example 1 and the two-channel extrusion dies #2 was used in Example 2. The outline structures and appearances of these two extrusion dies are shown in FIG. 5 and FIGS. 6(a), (b) and (c). The reference signs indicated in FIGS. 5 and 6 are given in the same manner as the embodiments described above. The two-channel extrusion die #1 seen on the left has diameters of big and small channels which are less than diameters of big and small channels of the two-channel extrusion die #2 seen on the right, respectively.

TABLE 1
Dimensions of Two-Channel Extrusion Die #1 for Example 1

| | Diameter | Diameter | Length | Length | |
|---|---|---|---|---|---|
| Die Dimension | (inch) | (mm) | (inch) | (mm) | L/D |
| Small Channel | 0.04 | 1.016 | 1 | 25.4 | 25.4 |
| Big Channel | 0.06 | 1.524 | 1.5 | 38.1 | 25.4 |

TABLE 2
Dimensions of Two-Channel Extrusion Die #2 for Example 2

| | Diameter | Diameter | Length | Length | |
|---|---|---|---|---|---|
| Die Dimension | (inch) | (mm) | (inch) | (mm) | L/D |
| Small Channel | 0.1 | 2.54 | 1 | 25.4 | 10 |
| Big Channel | 0.15 | 3.81 | 1.5 | 38.1 | 10 |

### Example 1

The two-channel extrusion dies #1 was mounted on an extruder with a screw diameter of 19 mm. A flexible PVC compound (commercially available from Rimtec Corp.) was used as a fluid for extrusion.

An extrusion test was conducted under the conditions of a temperature of 170° C. and a screw rotation number of 3 RPM. Shear rates (i.e., apparent shear rates) were calculated from the weights per unit time of extrudates from the big and small channels of the two-channel extrusion dies #1. The screw RPM, the pressure applied, the flow rates in the big and small channels, the shear rates in the big and small channels, and the apparent viscosity are shown in Table 3 below.

A slip velocity and a true shear viscosity of the fluid are determined based on the shear rates.

### Example 2

The two-channel extrusion dies #2 was mounted on an extruder with an extrusion diameter of 19 mm. A flexible PVC compound (commercially available from Rimtec Corp.) was used as a fluid for extrusion.

An extrusion test was conducted under the conditions of a temperature of 170° C. and a screw rotation number of 30 RPM. Shear rates (i.e., apparent shear rates) were calculated from the weights per unit time of extrudates from the big and small channels of the two-channel extrusion dies #2. The screw RPM, the pressure applied, the flow rates in the big and small channels, the shear rates in the big and small channels, and the apparent viscosity are shown in Table 3 below.

A slip velocity and a true shear viscosity of the fluid are determined based on the shear rates.

TABLE 3
Testing Results of Two-Channel Extrusion Dies with 19 mm Extruder

| | | | Flow rate | | Shear Rate | | |
|---|---|---|---|---|---|---|---|
| | Screw | Pressure | (g/min.) | | (1/s) | | Apparent Viscosity |
| Temp. 170 C. | RPM | (psi) | Big Channel | Small Channel | Big Channel | Small Channel | PaS |
| Example 1 | 3 | 2724 | 3.36 | 1.01 | 124 | 125.5 | 1497 |
| Example 2 | 30 | 94 | 21.0 | 6.3 | 51.6 | 52.6 | 1232 |

### REFERENCE SIGNS LIST

1: Cylindrical body
2: Adapter to an extruder
3A: Big channel
3Aᵢ: Inlet of big channel
3Aₒ: Outlet of big channel
3B: Small channel
3Bᵢ: Inlet of small channel
3Bₒ: Outlet of small channel
4: Semicylindrical convex part
5: Connecter to measurement instrument of fluid temperature and/or pressure
10: Two-channel extrusion die
F: Flow direction of fluid (when it is flown)
D_{A}: Diameter of big channel A
L_{A}: Longitudinal length of big channel A
C₁: Central line of big channel A
D_{B}: Diameter of small channel B
L_{B}: Longitudinal length of small channel B
C₂: Central line of small channel B
Cp: Central line (central point) of cylindrical body
S₁: Distance between center of big channel and center of cylindrical body
S₂: Distance between center of small channel and center of cylindrical body

1. A two-channel extrusion die for Mooney correction to determine true shear viscosity of a resin,
the two-channel extrusion die, comprising:
a cylindrical body;
two channels, each of the two channels having a circular and constant cross section and extending linearly throughout the channel along a longitudinal direction of the cylindrical body, and both inlets of the two channels existing in a plane perpendicular to the longitudinal direction of the cylindrical body, and
a convex part adapting to an extruder; and
when a big channel A being one of the two channels has a longitudinal length L_{A} along the longitudinal direction of the cylindrical body and a diameter D_{A} of a cross section perpendicular to the longitudinal direction, and a small channel B being the other of the two channels has a longitudinal length L_{B} along the longitudinal direction of the cylindrical body, and a diameter D_{B} of a cross section perpendicular to the longitudinal direction, all of three relations (i), (ii) and (iii) shown below being fulfilled, thereby causing each of the two channels to equally be under a given pressure head of from an inlet to an outlet of the channel during an extrusion operation of a fluid of the resin with the two-channel extrusion die:
$${L}_{A} > {L}_{B} \qquad ( i )$$
$${D}_{A} > {D}_{B} \qquad ( ii )$$
$${L}_{A} / {D}_{A} = {L}_{B} / {D}_{B} . \qquad ( iii )$$

2. The two-channel extrusion die according to claim 1, wherein a semicylindrical convex part is formed at a downstream end of the cylindrical body, and the big channel A passes through the semicylindrical convex part.

3. The two-channel extrusion die according to claim 1, wherein a center of the big channel A and a center of the small channel B are each equidistant from a center of the cylindrical body in a cross section perpendicular to the longitudinal direction of the cylindrical body.

4. The two-channel extrusion die according to claim 1,
wherein L_{A} is 1.1*L_{B} or larger and 2.0*L_{B} or smaller, and
wherein D_{A} is 1.1*D_{B} or larger and 2.0*D_{B} or smaller.

5. The two-channel extrusion die according to claim 1, wherein L_{A}/D_{A} and L_{B}/D_{B} are each 5 or more and 50 or less.

6. The two-channel extrusion die according to claim 1, further comprising a part connecting to an instrument to measure a temperature and/or pressure of a fluid of the resin to be extruded with the two-channel extrusion die.

7. A system for making Mooney correction to determine true shear viscosity of a resin with a rheometer, comprising an extruder and the two-channel extrusion die according to claim 1 connecting to the extruder.

8. A method of making Mooney correction to determine true shear viscosity of a resin with the use of the two-channel extrusion die according to claim 1, the method comprising the steps of:
extruding a fluid of the resin from the big channel A and the small channel B through the two-channel extrusion die connecting to an extruder, thereby collecting an extrude A from the big channel A and an extrude B from the small channel B;
measuring a weight A of the extrude A and a weight B of the extrude B;
calculating an apparent shear rate A from the weight A and an apparent shear rate B from the weight B;
applying Mooney correction to the apparent shear rate A and the apparent shear rate B, thereby determining a slip velocity of the fluid; and
calculating a true shear viscosity from the slip velocity of the fluid.
